(19) United States
(12) Patent Application Publication
(10) Pub. No.: US 2009/0249430 A1
(43) Pub. Date: Oct. 1, 2009

(54) CLAIM CATEGORY HANDLING

(75) Inventors: Duane F. Buss, West Mountain, UT (US); Andrew A. Hodgkinson, Pleasant Grove, UT (US); Dale R. Olds, Draper, UT (US); Daniel S. Sanders, Orem, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 12/054,774

(22) Filed: Mar. 25, 2008

(51) Int. Cl. G06F 21/00

(52) U.S. Cl. 726/1

(57) ABSTRACT

A relying party can have a security policy. The security policy can include claims that are categorized other than “required” and “optional”. The user can specify, in a user policy, whether or not to include in a request for a security token from an identity provider claims that are not “required”.

### RELATED APPLICATION DATA

This application is related to co-pending U.S. patent application Ser. No. 11/843,572, filed Aug. 22, 2007, to co-pending U.S. patent application Ser. No. 11/843,638, filed Aug. 22, 2007, to co-pending U.S. patent application Ser. No. 11/843,640, filed Aug. 22, 2007, to co-pending U.S. patent application Ser. No. 11/843,591, filed Aug. 22, 2007, to co-pending U.S. patent application Ser. No. 12/019,104, filed Jan. 24, 2008, to co-pending U.S. patent application Ser. No. 12/030,063, filed Feb. 12, 2008, to co-pending U.S. patent application Ser. No. 12/029,373, filed Feb. 11, 2008, to co-pending U.S. patent application Ser. No. 12/042,205, filed Mar. 4, 2008, and to co-pending U.S. patent application Ser. No. 12/026,775, filed Feb. 6, 2008, all of which are herein incorporated by reference for all purposes. Co-pending U.S. patent application Ser. No. 11/843,572, filed Aug. 22, 2007, co-pending U.S. patent application Ser. No. 11/843,638, filed Aug. 22, 2007, and co-pending U.S. patent application Ser. No. 11/843,640, filed Aug. 22, 2007, all claim the benefit of U.S. Provisional Patent Application Ser. No. 60/895,312, filed Mar. 16, 2007, U.S. Provisional Patent Application Ser. No. 60/895,316, filed Mar. 16, 2007, and U.S. Provisional Patent Application Ser. No. 60/895,325, filed Mar. 16, 2007, all of which are herein incorporated by reference for all purposes. Co-pending U.S. patent application Ser. No. 12/019,104, filed Jan. 24, 2008, claims the benefit of U.S. Provisional Patent Application Ser. No. 60/973,679, filed Sep. 19, 2007, which is herein incorporated by reference for all purposes.

### FIELD OF THE INVENTION

This invention pertains to using information cards, and more particularly to improving information flow to a relying party.

### BACKGROUND OF THE INVENTION

When a user interacts with sites on the Internet (hereafter referred to as “service providers” or “relying parties”), the service provider often expects to know something about the user that is requesting the services of the provider. The typical approach for a service provider is to require the user to log into or authenticate to the service provider's computer system. But this approach, while satisfactory for the service provider, is less than ideal to the user. First, the user must remember a username and password for each service provider who expects such information. Given that different computer systems impose different requirements, and the possibility that another user might have chosen the same username, the user might be unable to use the same username/password combination on each such computer system. (There is also the related problem that if the user uses the same username/password combination on multiple computer systems, someone who hacks one such computer system would be able to access other such computer systems.) Second, the user has no control over how the service provider uses the information it stores. If the service provider uses the stored information in a way the user does not want, the user has relatively little ability to prevent such abuse, or recourse after the fact.

To address this problem, new systems have been developed that allow the user a measure of control over the information stored about the user. Windows CardSpace™ (sometimes called CardSpace) is a Microsoft implementation of an identity meta-system that offers a solution to this problem. (Microsoft, Windows, and CardSpace are either registered trademarks or trademarks of Microsoft Corporation in the United States and/or other countries.) A user can store identity information with an identity provider the user trusts. When a service provider wants some information about the user, the user can control the release of information stored with the identity provider to the service provider. The user can then use the offered services that required the identity information.

When relying parties request the user to release information from an identity provider, the relying party has a choice: the requested information can be considered “required”—meaning the relying party is “unwilling” to proceed without the requested information—or “optional”—meaning that the relying party would like the information but does not “require” it. But these options do not adequately cover all situations. If the relying party indicates that all the information it wants is “required”, it might be that the user has no information card that can provide all of the requested data, and so the request cannot be satisfied. On the other hand, if the relying party indicates that all the information it wants is “optional”, every information card the user has can be applied, which does not help the user in selecting an appropriate information card. Further, providing the “optional” information is at the discretion of the user and requires the user to specifically indicate that the “optional” information should be provided. If the user does not make this request, the relying party might end up receiving a security token that includes no data at all!

A need remains for a way to addresses these and other problems associated with the prior art.

### SUMMARY OF THE INVENTION

In an embodiment of the invention, when a client requests to perform a transaction with a relying party, the relying party can issue a security policy. The security policy can include claims of different categories, and can include a claim that is neither “required” nor “optional”. The client can then issue a security token to the relying party, satisfying the claims of the security policy.

In another embodiment of the invention, a user can specify in a user policy how to automate the inclusion of claims in a security token that are not “required” in the security policy.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a sequence of communications between a client, a relying party, and an identity provider.

FIG. 2 shows a client that can receive a security policy including claims that can be “required”, “optional”, or of some other categorization, according to an embodiment of the invention.

FIG. 3 shows the relying party of FIG. 1 including the security policy and its association to the web site.

FIG. 4 shows the security policy of FIG. 1 including claims categorized other than “required” or “optional”.

FIG. 5 shows a user policy of FIG. 2, specifying how to handle non-“required” claims in a security policy.

FIG. 6 shows the card selector of FIG. 2 ranking information cards to satisfy a security policy, based on the user policy.

FIG. 7 shows the card selector of FIG. 2 presenting the client with visual and/or non-visual cues about which information cards best satisfy the user policy.

FIG. 8 shows a flowchart of a procedure for the client of FIGS. 1 and 2 to satisfy a security policy.

FIG. 9 shows a flowchart of a procedure for the client of FIGS. 1 and 2 to use the user policy to identify information cards that satisfy the security policy.

FIG. 10 shows a flowchart of a procedure for the user policy of FIG. 2 to be used in response to a request for a claim that is not “required”.

FIG. 11 shows a flowchart of a procedure for the relying party of FIG. 1 to engage in a transaction with a client.

### DETAILED DESCRIPTION OF THE PREFERRED EMBODIMENT

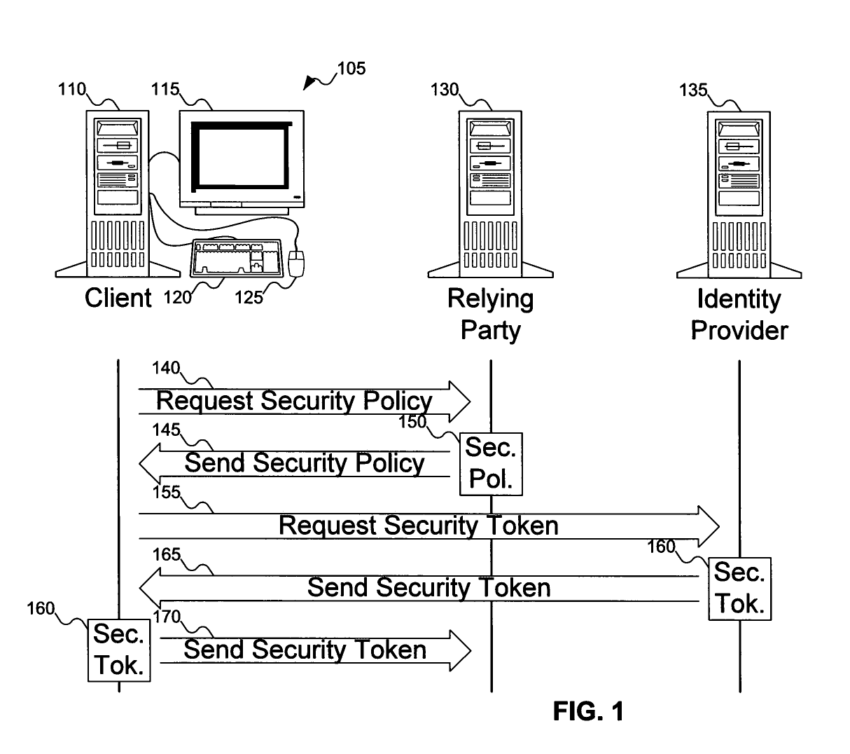

Before explaining the invention, it is important to understand the context of the invention. FIG. 1 shows a sequence of communications between a client, a relying party, and an identity provider. For simplicity, each party (the client, the relying party, and the identity provider) may be referred to by their machines. Actions attributed to each party are taken by that party's machine, except where the context indicates the actions are taken by the actual party.

In FIG. 1, computer system 105, the client, is shown as including computer 110, monitor 115, keyboard 120, and mouse 125. A person skilled in the art will recognize that other components can be included with computer system 105: for example, other input/output devices, such as a printer. In addition, FIG. 1 does not show some of the conventional internal components of computer system 105: for example, a central processing unit, memory, storage, etc. Although not shown in FIG. 1, a person skilled in the art will recognize that computer system 105 can interact with other computer systems, such as relying party 130 and identity provider 135, either directly or over a network (not shown) of any type. Finally, although FIG. 1 shows computer system 105 as a conventional desktop computer, a person skilled in the art will recognize that computer system 105 can be any type of machine or computing device capable of providing the services attributed herein to computer system 105, including, for example, a laptop computer, a personal digital assistant (PDA), or a cellular telephone.

Relying party 130 is a machine managed by a party that relies in some way on the identity of the user of computer system 105. The operator of relying party 130 can be any type of relying party. For example, the operator of relying party 130 can be a merchant running a business on a website. Or, the operator of relying party 130 can be an entity that offers assistance on some matter to registered parties. Relying party 130 is so named because it relies on establishing some identifying information about the user.

Identity provider 135, on the other hand, is managed by a party responsible for providing identity information (or other such information) about the user for consumption by the relying party. Depending on the type of information identity provider 135 stores for a user, a single user might store identifying information with a number of different identity providers 135, any of which might be able to satisfy the request of the relying party. For example, identity provider 135 might be a governmental agency, responsible for storing information generated by the government, such as a driver's license number or a social security number. Or, identity provider 135 might be a third party that is in the business of managing identity information on behalf of users.

The conventional methodology of releasing identity information can be found in a number of sources. One such source is Microsoft Corporation, which has published a document entitled Introducing Windows CardSpace, which can be found on the World Wide Web at http://msdn2.microsoft.com/en-us/library/aa5051205aspx and is herein incorporated by reference. To summarize the operation of Windows CardSpace, when a user wants to access some data from relying party 130, computer system 105 requests the security policy of relying party 130, as shown in communication 140, which is returned in communication 145 as security policy 150. Security policy 150 is a summary of the information relying party 130 needs, how the information should be formatted, and so on.

Once computer system 105 has security policy 150, computer system 105 can identify which information cards will satisfy security policy 150. Different security policies might result in different information cards being usable. For example, if relying party 130 simply needs an e-mail address, the information cards that will satisfy this security policy might be different from the information cards that satisfy a security policy requesting the user's full name, mailing address, and social security number. The user can then select an information card that satisfies security policy 150.

Once the user has selected an acceptable information card, computer system 105 uses the selected information card to transmit a request for a security token from identity provider 135, as shown in communication 155. This request can identify the data to be included in the security token, the credential that identifies the user, and other data the identity provider needs to generate the security token. Identity provider 135 returns security token 160, as shown in communication 165. Security token 160 includes a number of claims, or pieces of information, that include the data the user wants to release to the relying party. Security token 160 is usually encrypted in some manner, and perhaps signed and/or time-stamped by identity provider 135, so that relying party 130 can be certain that the security token originated with identity provider 135 (as opposed to being spoofed by someone intent on defrauding relying party 130). Computer system 105 then forwards security token 160 to relying party 130, as shown in communication 170.

In addition, the selected information card can be a self-issued information card: that is, an information card issued not by an identity provider, but by computer system 105 itself. In that case, identity provider 135 effectively becomes part of computer system 105.

In this model, a person skilled in the art will recognize that because all information flows through computer system 105, the user has a measure of control over the release of the user's identity information. Relying party 130 only receives the information the user wants relying party 130 to have, and does not store that information on behalf of the user (although it would be possible for relying party 130 to store the information in security token 160: there is no effective way to prevent such an act).

The problem with this model is, as noted above, that the relying party is limited to requesting claims of only two types: “required” and “optional”. An example might help to explain the problem with this model. Consider a relying party web site that includes a form to be filled in by the user. Alternatively, this form can be filled in using data from one of the user's information cards. That is, when the user visits the web site, the browser on the client's machine can detect that there is a form fill that could be satisfied with an information card, and invoke the card selector.

If the relying party marks every field in the form as “required”, then the user has to have a single information card that includes data to satisfy all of the form fields. If the user does not have a single information card that can satisfy all the form fields, then the user cannot fill in the form using the card selector.

On the other hand, if the relying party marks every field in the form as “optional” (in other words, no field is “required”), then every information card can satisfy the security policy—the card selector only uses the “required” fields to identify information cards that satisfy the security policy. Worse, as noted above, the current model requires the user to actively opt to satisfy “optional” claims in the security policy. If the user forgets to specify that “optional” claims are included in the security token, the result can be that the identity provider issues a security token that does not satisfy a single claim in the security policy: no benefit is gained from using the information card in dealing with the relying party. In addition, the current model takes an “all or nothing” approach with respect to “optional” claims: either all “optional” claims are included in the security token, or none of them are included. Finally, it is possible for the relying party to include “optional” claims that conflict—where the user does not have an information card that can satisfy all “optional” claims—for example, in a form fill. In such a situation, the current model, being “all or nothing”, would have to omit the “optional” claims.

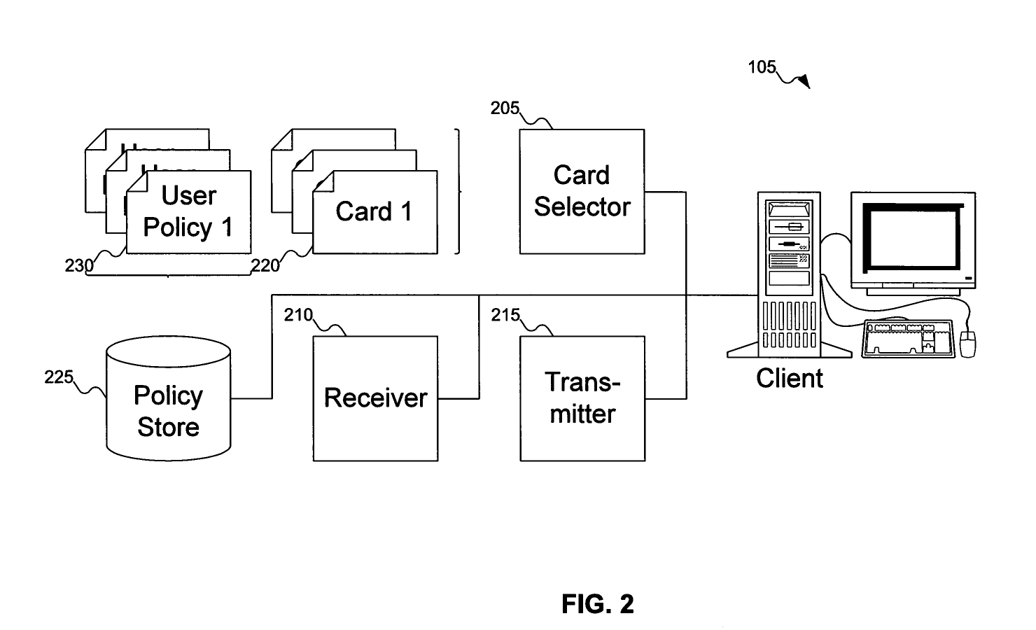

Now that the problem—identifying claims in the security policy as something other than “required” or “optional”—is understood, embodiments of the invention can be explained. FIG. 2 shows a client equipped to handle claims in a security policy that are not identified as either “required” or “optional”, according to embodiments of the invention. In FIG. 2, computer system 105 includes card selector 205, receiver 210, and transmitter 215. Card selector 205 enables a user to select information card 220 that satisfies the security policy. Receiver 210 receives data transmitted to computer system 105, and transmitter 215 transmits information from computer system 105. These components are the same as those found in computer system 105 as shown in FIG. 1.

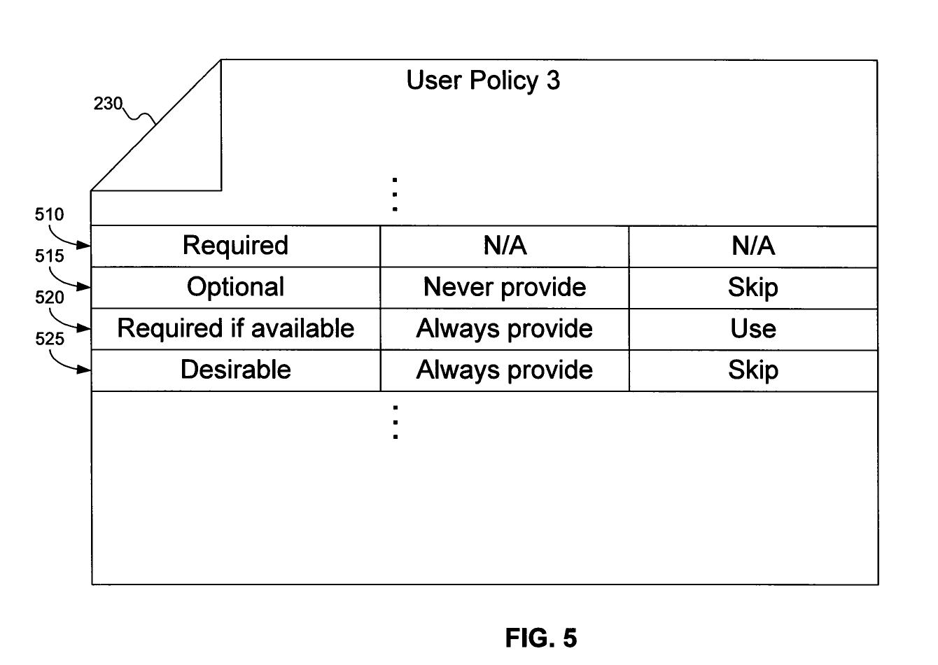

In addition to these components, computer system 105 includes policy store 225, which stores policies such as user policy 230. User policy 1305, discussed below with reference to FIG. 5, defines the user's preference for handling claims in the security policy that are not required.

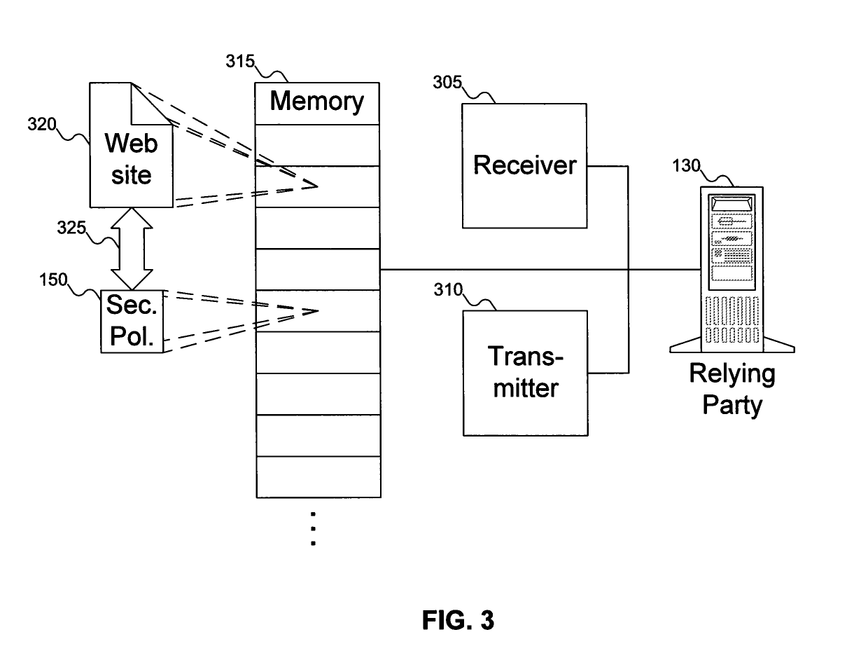

FIG. 3 shows the relying party of FIG. 1 including the security policy and its association to the web site. In FIG. 3, relying party 130 includes receiver 305 and transmitter 310. Receiver 305 receives data transmitted to relying party 130, and transmitter 310 transmits data from relying party 130.

Relying party 130, as a machine such as a computer, includes memory 315. Memory 315 is used as any computer memory can be used. Memory 315 can be any form of storage: for example, Random Access Memory (RAM), Read-Only Memory (ROM), flash memory, or any other form of memory. In addition, memory 315 can include storage media such as hard drives, optical storage, and any other medium that can store information and be accessible by relying party 130.

Among the other data that can be stored in memory 315 are web site 320 and security policy 150. Web site 320 is the web site displayed to consumers, and includes functionality that can use information cards in some way: for example, for user identification or form fill. Security policy 150 is a security policy associated with web site 320 (as shown by arrow 325). Security policy 150 is typically predefined for associated web site 320 (as the web site and the security policy do not change often), although a person skilled in the art will recognize that security policy 150 can be built dynamically based on the current state of web site 320.

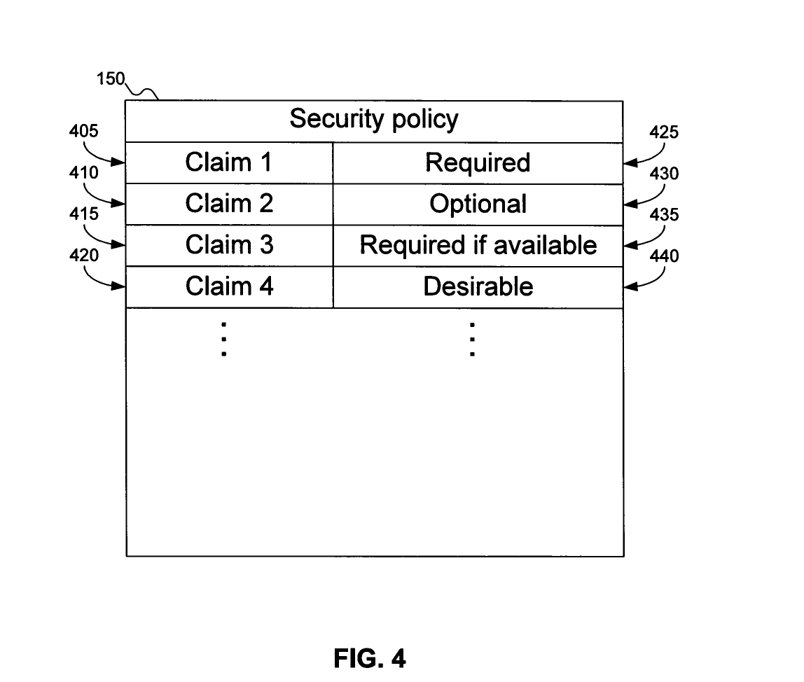

Among other data, security policy 150 can include claims—pieces of data relying party 130 wants. FIG. 4 shows detail about how security policy 150 can be represented. A person skilled in the art will recognize that security policy 150 is represented in FIG. 4 in a stylized form, as security policies are typically described using the Web Services Security Policy Language (WS-SecurityPolicy), but the representation of security policy 150 in FIG. 4 can be easier to understand, especially with reference to embodiments of the invention.

In FIG. 4, security policy 150 includes four claims 405, 410, 415, and 420, but a person skilled in the art will recognize that security policy 150 can include any number of claims. Associated with each claim is a claim category: in essence, an indication of how important that particular claim is to the relying party. Whereas in the past claims could only be categorized as “required” or “optional”, as with claims 405 and 410 (with corresponding claim categories 425 and 430), embodiments of the invention permit other claim categories to be used. For example, claim 415 is categorized as “required if available” in claim category 435, indicating that the relying party expects this claim to be satisfied if the selected information card includes the desired data, but the relying party will accept a security token that does not include this claim if the data is not available. Similarly, claim 420 is categorized as “desirable” in claim category 440, suggesting that the relying party would like to have this claim satisfied, but can live without it. “Desirable” can be viewed as a less critical categorization than “required if available”: “desirable” leaves the inclusion of the claims more up to the user than “required if available”, which in effect “demands” the inclusion of the claim if the information card can satisfy the claim.

While FIG. 4 shows two categorizations other than “required” and “optional”—namely, “required if available” and “desirable”—a person skilled in the art will recognize that there can be any number of categorizations, and that these categorizations can be identified using any desired terminology. In addition, the terminology used is not limited to only English-language terminology. For example, claim categories can be identified by numbers: 0=“optional”, 1=“required”, and any number greater than 1 can specify a category between “required” and “optional”.

With new claim categories being defined, indicating that claims are less than “required” but considered more than “optional”, the question becomes should the security token include the claims or not. Actually, this was an issue of sorts with “optional” claims, but with only the one claim category, the simplest solution was to let the user decide on a case-by-case basis whether or not to include the “optional” claims. But with claims of different categories, it makes sense to let a user define how to handle different claim categories. FIG. 5 shows an example of how a user policy can be defined.

In FIG. 5, the user has specified how “required”, “optional”, “required if available”, and “desirable” claims are handled, in entries 510, 515, 520, and 525. As “required” claims are always required, entry 510 indicates that the user does not have the ability to control whether “required” claims are provided in the security token, or used in identifying information cards that can satisfy the security policy. Entry 515 indicates that “optional” claims are never provided (even if included in the information card), and are skipped in identifying information cards that can satisfy the security policy. By indicating that “optional” claims are to be skipped, the user has indicated that an information card does not have to include any optional claims to be considered as satisfying the security policy. In entry 520, the user has indicated that “required if available” claims are always provided (if included in the information card), and that an information card needs to include these claims to be considered as satisfying the security policy. Finally, in entry 525, the user has indicated that “desirable” claims are always provided (if included in the information card), but are not used in identifying an information card that can satisfy the security policy. (The missing combination—never providing a particular set of claims, but requiring that an information card include those claims to satisfy the security policy—is also possible, although considered unlikely).

By indicating that “required if available” claims are to be used in identifying information cards that satisfy the security policy, the user is essentially saying that the user considers these claims to be treated the same as “required” claims: the user wants the available information cards to include these claims. This can help to reduce the number of information cards that can satisfy the security policy. The risk is that the user might eliminate information cards that the user might prefer to use, but do not include the “required if available” claims. But indicating that too many claims are to be treated as “required”, the user might even eliminate all possible information cards: that is, there might be no information card that can satisfy the security policy, based on the user's policy.

User policy 230 can also allow the user to specify how to handle “optional” claims. More particularly, the user does not have to remember to specify including “optional” claims in the security token: the user policy can indicate whether “optional” claims are included or not.

A person skilled in the art will recognize that user policy 230 is shown in a stylized form. A person skilled in the art will also recognize how the user can specify and modify a user policy: for example, via a form on his machine.

Although user policy 230 of FIG. 5 shows two options each for whether or not claims are included in the security token and whether or not claims are used in determining whether an information card satisfies a security policy, a person skilled in the art will recognize that other options can be used. For example, the user policy can specify that the user decide on a case-by-case basis whether or not claims are included in the security token. This could result in the system prompting the user individually regarding each “optional” claim whether to include or omit the “optional” claims, among other possibilities. Or, the user policy can specify that claims are preferred to be in the information card to satisfy the security policy, without absolutely requiring the claims. A person skilled in the art will recognize other possibilities both for whether claims are included in the security token and for whether claims are necessary to satisfy the security policy.

There are other ways in which user policy 230 can be used. The user can define a claim group—a set of claims that the user considers to be related in some way. For example, the user can define a claim group called “shipping information”, and specify that that claim group includes any claims relating to the users shipping information. Thus, the “shipping information” claim group can include the user's name, address, telephone number, e-mail address, and so on. User policy 230 can specify that any claim in the “shipping information” claim group is to be included in the security policy, even if that claim is marked “optional” by the relying party. Then, when a security policy specifies any claim included in the “shipping information” claim group, user policy 230 can be applied. User policy 230 can specify the inclusion of claims in the claim group, even if another policy might indicate that the claim is to be omitted: for example, if another user policy specifies that “optional” claims are not to be included in the security token.

Co-pending U.S. patent application Ser. No. 11/843,591, titled “CREDENTIAL CATEGORIZATION”, filed Aug. 22, 2007, which is herein incorporated by reference for all purposes, describes ways in which information cards can be categorized. User policy 230 can use this information to specify how to handle claims in embodiment of this invention. User policy 230 can specify that when an information card from a particular credential categorization is used, different rules can be applied for the inclusion of the claims in the security token. For example, user policy to 30 can state that one in information card is used from a particular credential categorization, “optional” claims are never to be included, even if the default policy would include the claims. A person skilled in the art will recognize other ways in which embodiments of this invention can be combined with embodiments of U.S. patent application Ser. No. 11/843,591, titled “CREDENTIAL CATEGORIZATION”, filed Aug. 22, 2007.

The above description focuses on a model where a single information card is used to generate a single security token. A person skilled in the art will recognize that it is possible for multiple information cards to be selected, and for the claims of the selected multiple information cards to be combined into a single security token, as generated by a security token generator. User policy 230 can also be used to manage the combination of claims from multiple information cards.

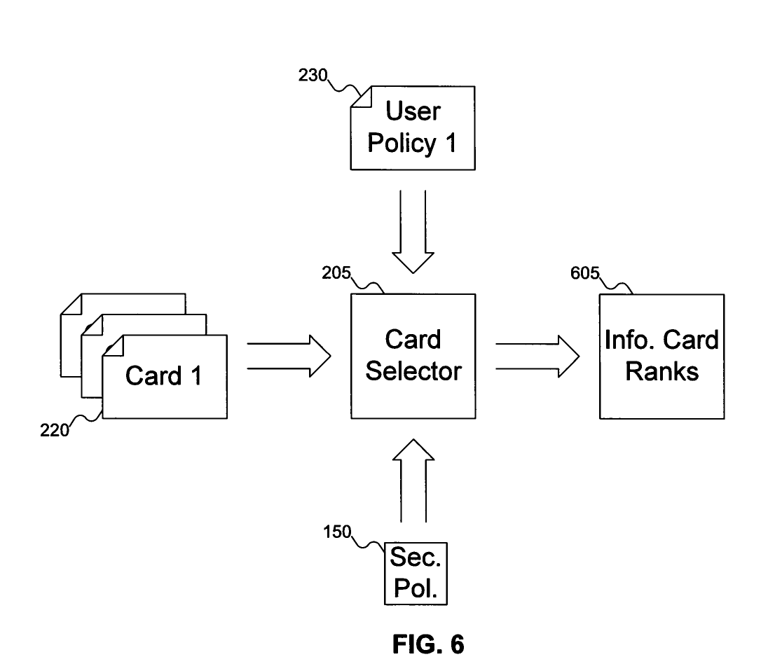

As just discussed, in one embodiment the user policy can specify that one (or more) category of claims are preferred to be in the information card, without absolutely having to be present, to satisfy the security policy. In such situations, where it is not an up-or-down decision as to whether an information card satisfies the security policy, the card selector can provide the user with information about how well each information card satisfies the security policy. FIG. 6 shows the card selector of FIG. 2 ranking information cards to satisfy a security policy, based on the user policy. In FIG. 6, card selector 205 takes security policy 150, information cards like information card 220, and user policy 230, and identifies which information cards satisfy security policy 150, based on user policy 230. Card selector 205 can then rank the information cards based on how well they satisfy the security policy 150, shown as ranked information cards 605. By ranking the information cards, card selector 205 can give the user a clue about which information cards best satisfy security policy 150.

In one embodiment of the invention, card selector 205 can rank the information cards is by how many claims from the security policy the information card can satisfy. For example, one information card might include three claims the user specified to include in identifying information cards that satisfy the security policy, and another information card might include five such claims. In another embodiment of the invention, if user policy 230 specifies including claims from different categories of claims, card selector 205 might rank more highly the information cards that satisfy more claims from “higher” categories. For example, even if one information card includes three non-“required” claims and another information card includes five non-“required” claims, if the three non-“required” claims are all “required if available” claims and the five non-“required” claims are “desirable” claims, the information card including the three “required if available” claims can be ranked higher than the information card including the five “desirable” claims.

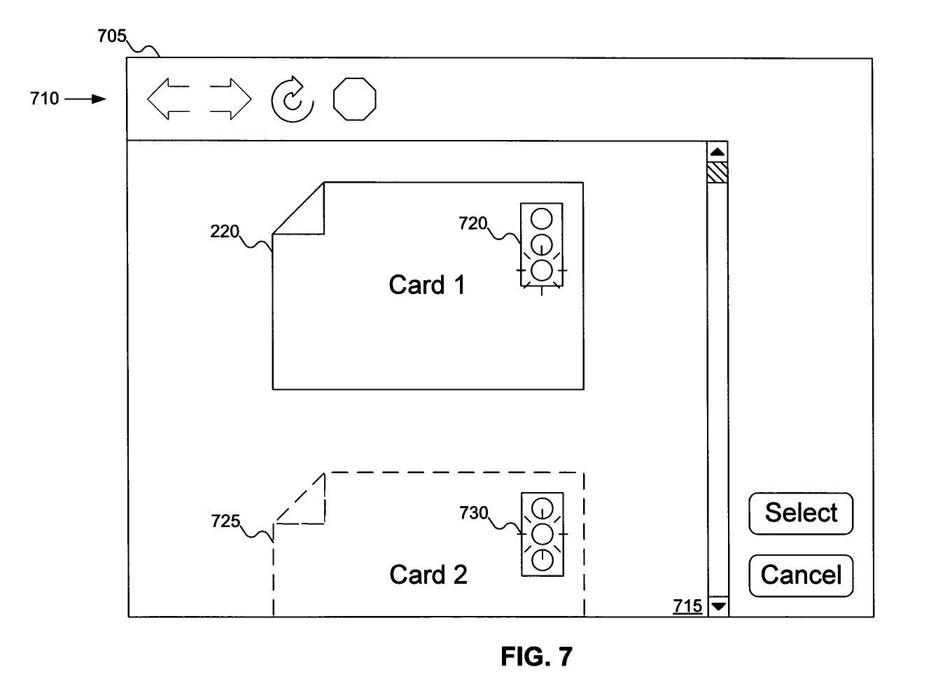

Once the information cards are ranked, card selector 205 can provide this information to the user. One way card selector 205 can provide this information is by using visual and/or non-visual cues. Co-pending U.S. patent application Ser. No. 12/029,373, titled “VISUAL AND NON-VISUAL CUES FOR CONVEYING/DISPLAYING STATE OF INFORMATION CARDS, ELECTRONIC WALLETS, AND KEYRINGS”, filed Feb. 11, 2008, which is herein incorporated by reference, describes how visual and non-visual cues can be used to present information to the user. FIG. 7, which shows the card selector of FIG. 2 presenting the client with visual and/or non-visual cues about which information cards best satisfy the user policy, shows screen 705, which shows what card selector 205 might display to the user. Among other options, screen 705 can include navigation buttons 710, to permit the user to navigate around within card selector 205. Screen 705 can also include a main area 715, where cards can be displayed to the user.

In main area 715, one card (and a portion of a second card) are shown. Information card 220 is shown with “green traffic light” 720, which indicates to the user that information card 220 completely satisfies the security policy, based on the user policy. (Depending on how the visual cues are defined, “green traffic light” 720 might be used even if information card 220 only “mostly” satisfies the security policy based on the user policy.) In contrast, information card 725 is not as good a match for the security policy based on the user policy, and so “yellow traffic light” 730 has been used. A person skilled in the art will recognize that, aside from “traffic light” cues, any other visual and/or non-visual cues can be used: the “traffic light” cues shown in FIG. 7 are merely exemplary.

Card selector 205 can also provide the user with information about why the information cards are tagged as they are. For example, card selector 205 can advise the user that a particular information card includes a claim that, while not “required”, is important to the relying party. Similarly, card selector 205 can indicate to the user that a particular information card, while otherwise satisfactory, does not include every claim the relying party wants, or omits a claim the relying party considers important.

While the problem was initially described above with reference to FIG. 1 in the context of a user visiting a web site maintained by a relying party, a person skilled in the art will recognize that embodiments of the invention are not limited to web sites. Embodiments of the invention can be used in any situation where the relying party wants to categorize claims beyond just “required” and “optional”. Further, even if the security policy received by the card selector only describes claims as “required” or “optional”, embodiments of the invention can be used to avoid the need for the user to manually and specifically request inclusion of optional claims.

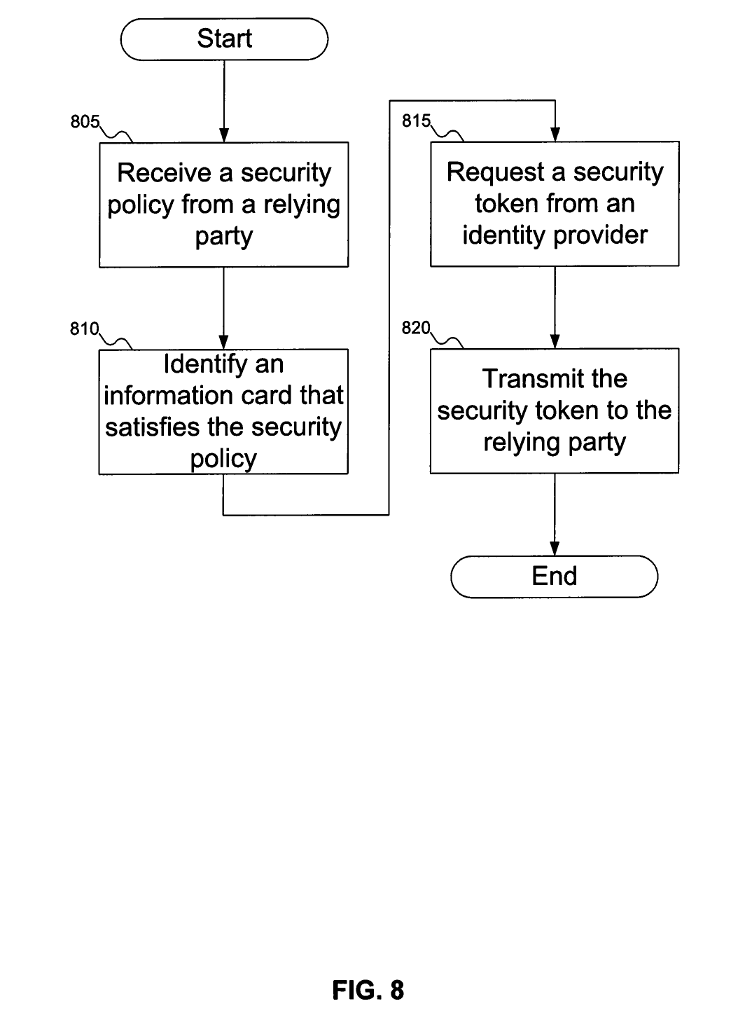

FIG. 8 shows a flowchart of a procedure for the client of FIGS. 1 and 2 to satisfy a security policy. In FIG. 8, at block 805, the client receives a security policy from the relying party. At block 810, the client identifies an information card that satisfies the security policy. This can include presenting one or more information cards that satisfy the security policy (to varying degrees) and receiving the user's selection of the information card to use. At block 815, the client requests a security token from an identity provider. This can include specifying which claims that are not “required” are to be included in the security token. Finally, at block 820, after receiving the security token from the identity provider, the client transmits the security token to the relying party.

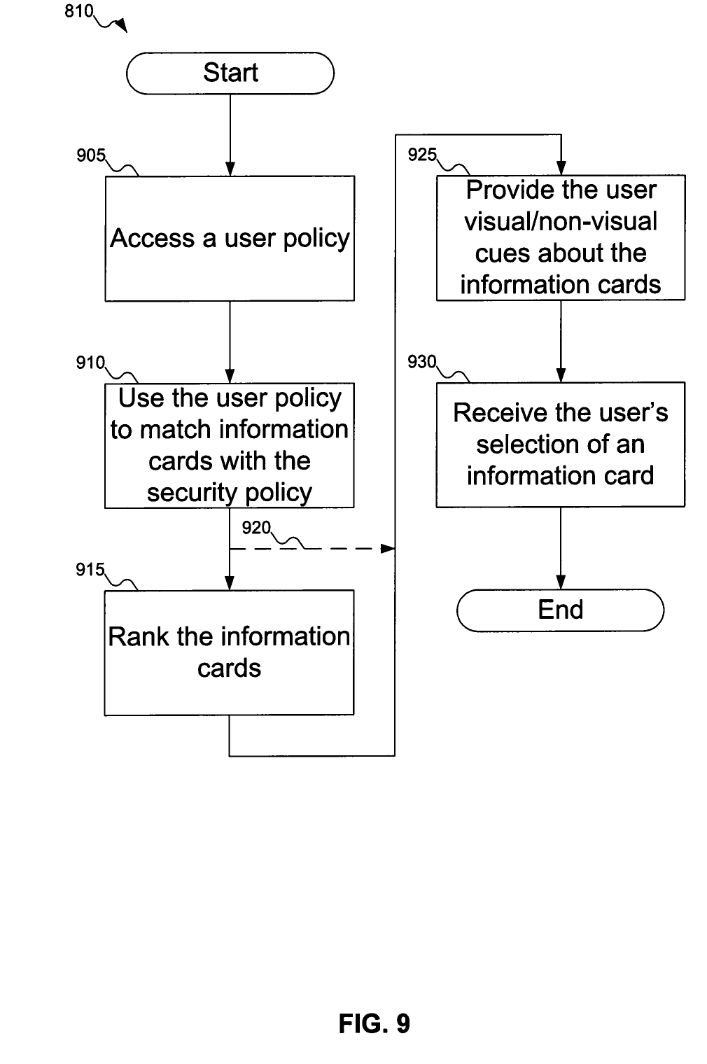

FIG. 9 shows a flowchart of a procedure for the client of FIGS. 1 and 2 to use the user policy to identify information cards that satisfy the security policy. FIG. 9 shows more detail about how an information card is selected at block 810 of FIG. 8. In FIG. 9, at block 905, the card selector accesses a user policy. At block 910, the card selector uses the user policy to match information cards with the security policy. This can involve identifying only information cards that completely satisfy the security policy, or information cards that satisfy the security policy to varying degrees. At block 915, the card selector ranks the information cards. As shown by dashed line 920, block 915 can be omitted. At block 925, the card selector provides the user with visual and/or non-visual cues regarding how well the information cards match the security policy. Finally, at block 930, the card selector receives the user's selection of an information card to use in requesting a security token.

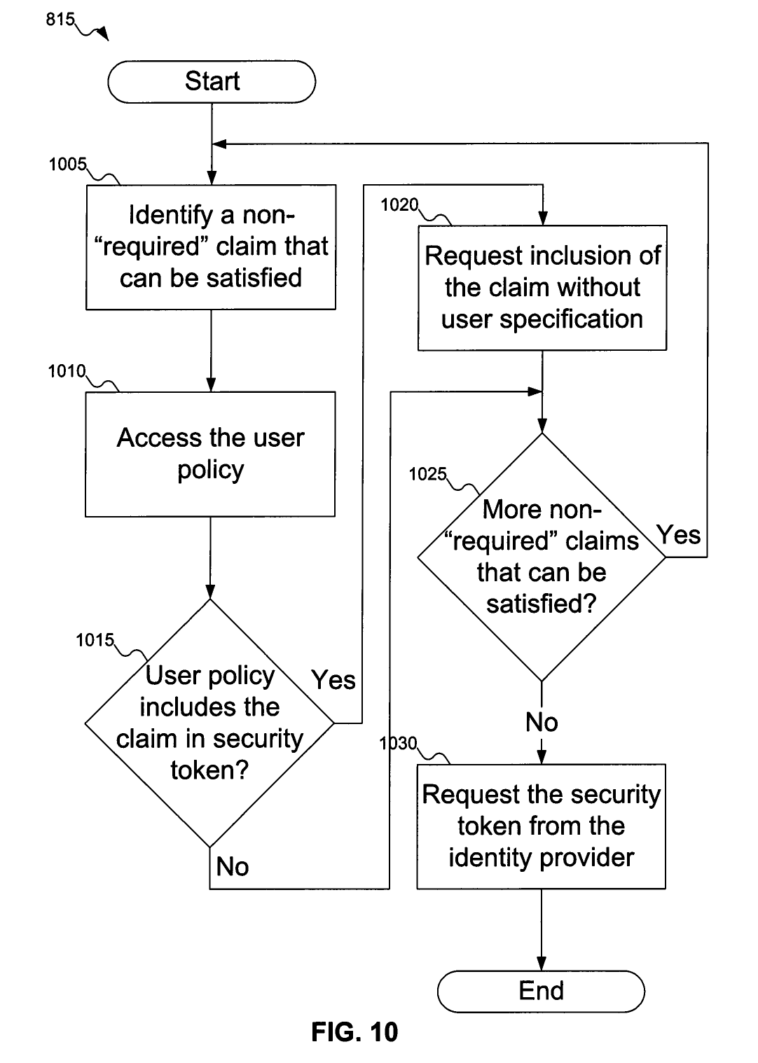

FIG. 10 shows a flowchart of a procedure for the user policy of FIG. 2 to be used in response to a request for a claim that is not “required”. Note that FIG. 10 can be used for any non-“required” claim, including, for example, “optional” claims. FIG. 10 shows more detail about how a security token is requested at block 815 of FIG. 8. In FIG. 10, at block 1005, the system identifies a claim that is not “required” but that can be satisfied by the information card. At block 1010, the system accesses the user policy to determine how the non-“required” claim is to be handled. At block 1015, the system follows the instructions of the user policy. If the user policy specifies that the non-“required” claim is to be included in the security token, then at block 1020 the system requests inclusion of the non-“required” claim in the security token, without the user having to specify inclusion of the claim.

Regardless of whether or not the non-“required” claim was requested to be included in the security token, at block 1025 the system determines if there are any more non-“required” claims that can be satisfied by the information card. If there are, then control returns to block 1005; otherwise, at block 1030, the system requests the security token (including all of the appropriate non-“required” claims) from the identity provider.

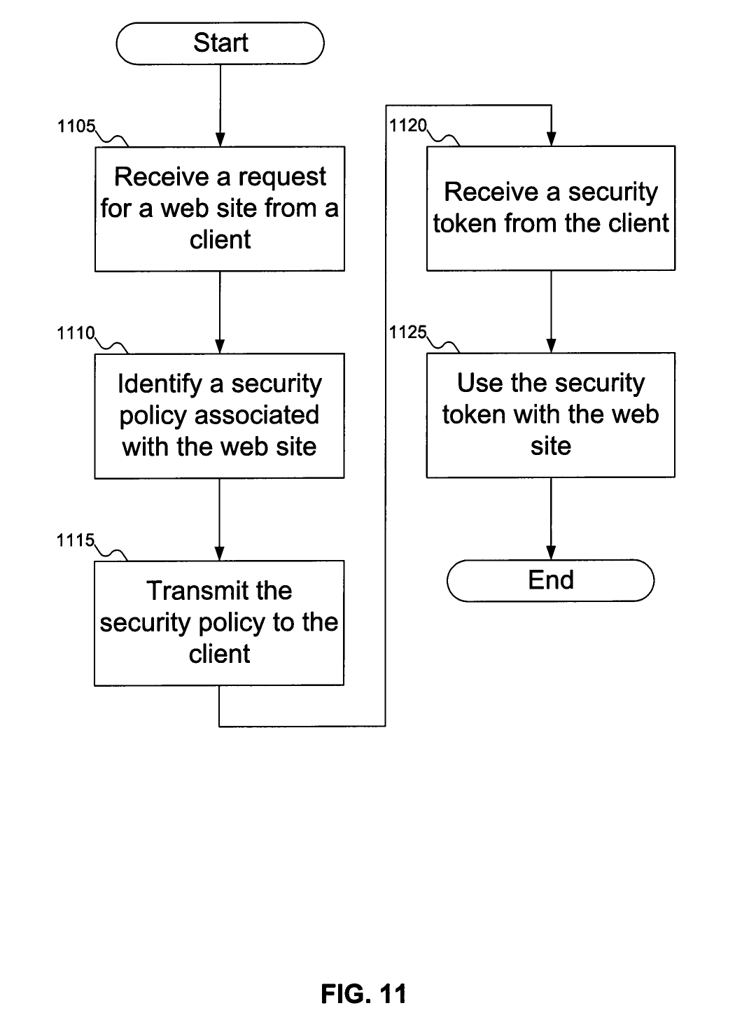

FIG. 11 shows a flowchart of a procedure for the relying party of FIG. 1 to engage in a transaction with a client. In FIG. 11, at block 1105, the relying party receives a request for a web site from a client. The transmission of the web site to the client can cause the client to invoke the card selector. At block 1110, the relying party identifies a security policy associated with the web site. At block 1115, the relying party transmits the security policy to the client. This security policy can specify claims that can be categorized other than “required” or “optional”. At block 1120, the relying party receives a security token from the client. At block 1125, the relying party uses the security token with the web site: for example, to verify the user's identity, or to fill in a form automatically for the user.

The following discussion is intended to provide a brief, general description of a suitable machine in which certain aspects of the invention may be implemented. Typically, the machine includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, Application Specific Integrated Circuits, embedded computers, smart cards, and the like. The machine may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

The invention may be described by reference to or in conjunction with associated data including functions, procedures, data structures, application programs, instructions, etc. which, when accessed by a machine, result in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, and other tangible, physical storage media. Associated data may also be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. An apparatus, comprising:
a machine (105);
a card selector (205) on the machine (105) to receive a selection of an information card (220) from a user;
a receiver (210) to receive a security policy (150) from a relying party (130) used in identifying said information card (220), and a security token (160) responsive to said security policy (150) from an identity provider (135); and
a transmitter (215) to transmit said security policy (150) to said identity provider (135) and said security token (160) to said relying party (130), said security token (160) responsive to said security policy (150),
wherein said security policy (150) includes at least one claim (405, 410, 415, 420) that the relying party (130) considers neither required nor optional (435, 440).

2. An apparatus according to claim 1, further comprising a policy store (225) to store a user policy (230) used to match said information card (220) with said security policy (150).

3. An apparatus according to claim 2, wherein said user policy (230) can specify that said security token (160) automatically includes a second claim (405, 410, 415, 420) of said security policy (150) that is not required (430, 435, 440), without manual user specification (510) of inclusion of said second claim (405, 410, 415, 420).

4. An apparatus according to claim 2, wherein the card selector (205) is operative to use said user policy (230) to identify said information card (220).

5. An apparatus according to claim 4, wherein the card selector (205) is further operative to use said user policy (230) to rank (605) a plurality of information cards according to their suitability as a match for said security policy (150).

6. An apparatus according to claim 5, wherein the card selector (205) is operative to rank (605) one of said plurality of information cards based on said one of said plurality of information cards matches a proper subset of all claims (405, 410, 415, 420) in said security policy (150), said proper subset of all claims (405, 410, 415, 420) including said at least one claim (405, 410, 415, 420) that the relying party (130) considers neither required nor optional (435, 440).

7. An apparatus according to claim 5, wherein the card selector (205) is further operative to provide a user visual and/or non-visual cues (735, 630) regarding said ranks (605) for said plurality of information cards.

8. An apparatus, comprising:
a machine (130);
memory (315) in the machine (130);
a web site (320) stored in the memory (315) in the machine (130); and
a security policy (150) associated with the web site (320), the security policy (150) including at least one claim (405, 410, 415, 420) that is neither required nor optional (435, 440) for use of the web site (320).

9. An apparatus according to claim 8, further comprising a transmitter (310) to transmit the security policy (150) to a client (105) responsive to said client (105) requesting the web site (320).

10. An apparatus according to claim 8, wherein the security policy (150) further includes at least one claim (405, 410, 415, 420) that is either required or optional (425, 430) for use of the web site (320).

11. A security policy data structure stored in memory (315), comprising:
a first claim (405, 410, 415, 420) considered either required or optional (425, 430) by a relying party (130); ad a second claim (405, 410, 415, 420) considered neither required nor optional (435, 440) by said relying party (130).

12. A security policy data structure according to claim 11, further comprising a third claim (405, 410, 415, 420) considered neither required nor optional (435, 440) by said relying party (130), and categorized differently from the second claim (405, 410, 415, 420).

13. A method, comprising:
receiving (805) a security policy (150) from a relying party (130), the security policy (150) including at least one claim (405, 410, 415, 420) that the relying party (130) considers neither required nor optional (435, 440);
identifying (810) an information card (220) that satisfies the security policy (150);
requesting (815) a security token (160) from an identity provider (135) in response to the security token (160); and
transmitting (820) the security token (160) to the relying party (130).

14. A method according to claim 13, wherein identifying (810) an information card (220) includes:
accessing (905) a user policy (230); and
using (910) the user policy (230) to match the information card (220) with the security policy (150).

15. A method according to claim 14, wherein requesting (815) a security token (160) from an identity provider (135) includes:
identifying (1005) a second claim (405, 410, 415, 420) in the security token (160) that is not required (430, 435, 440) by the relying party (130) that can be satisfied by the information card (220); and
automatically requesting (1020) inclusion of the second claim (405, 410, 415, 420) in the security token (160) without manual user specification (510) of inclusion of the second claim (405, 410, 415, 420).

16. A method according to claim 14, wherein using (910) the user policy (230) includes ranking (915) a plurality of information cards according to their suitability as a match for the security policy (150).

17. A method according to claim 16, wherein ranking (915) a plurality of information cards according to their suitability as a match for the security policy (150) includes ranking (915) at least one of the plurality of information cards according to its suitability as a match for the security policy (150), where the one of the plurality of information cards matches a proper subset of all claims (405, 410, 415, 420) in the security policy (150), the proper subset of all claims (405, 410, 415, 420) including the at least one claim (405, 410, 415, 420) that the relying party (130) considers neither required nor optional (435, 440).

18. A method according to claim 14, wherein identifying (810) an information card (220) that satisfied the security policy (150) further includes providing (925) a user visual and/or non-visual cues (735, 630) regarding said ranks (605) for said plurality of information cards.

19. A method, comprising:
receiving (1105) a request for a web site (320) at a relying party (130) from a client (105);
identifying (1110) a security policy (150) associated with the web site (320), the security policy (150) including at least one claim (405, 410, 415, 420) that is neither required nor optional (435, 440) for use of the web site (320); and
transmitting (1115) the security policy (150) to the client (105).

20. A method according to claim 19, further comprising:
receiving (1120) a security token (160) from the client (105), the security token including data responsive to the claim (405, 410, 415, 420) that is neither required nor optional (435, 440) for use of the web site (320); and
using (1125) the security token (160) with the web site (320).

21. An article, comprising a storage medium, said storage medium having stored thereon instructions that, when executed by a machine, result in:
receiving (805) a security policy (150) from a relying party (130), the security policy (150) including at least one claim (405, 410, 415, 420) that the relying party (130) considers neither required nor optional (435, 440);
identifying (810) an information card (220) that satisfies the security policy (150);
requesting (815) a security token (160) from an identity provider (135) in response to the security token (160); and
transmitting (820) the security token (160) to the relying party (130).

22. An article according to claim 21, wherein identifying (810) an information card (220) includes:
accessing (905) a user policy (230); and
using (910) the user policy (230) to match the information card (220) with the security policy (150).

23. An article according to claim 22, wherein requesting (815) a security token (160) from an identity provider (135) includes:
identifying (1005) a second claim (405, 410, 415, 420) in the security token (160) that is not required (430, 435, 440) by the relying party (130) that can be satisfied by the information card (220); and
automatically requesting (1020) inclusion of the second claim (405, 410, 415, 420) in the security token (160) without manual user specification (510) of inclusion of the second claim (405, 410, 415, 420).

24. An article according to claim 22, wherein using (910) the user policy (230) includes ranking (915) a plurality of information cards according to their suitability as a match for the security policy (150).

25. An article according to claim 24, wherein ranking (915) a plurality of information cards according to their suitability as a match for the security policy (150) includes ranking (915) at least one of the plurality of information cards according to its suitability as a match for the security policy (150), where the one of the plurality of information cards matches a proper subset of all claims (405, 410, 415, 420) in the security policy (150), the proper subset of all claims (405, 410, 415, 420) including the at least one claim (405, 410, 415, 420) that the relying party (130) considers neither required nor optional (435, 440).

26. An article according to claim 22, wherein identifying (810) an information card (220) that satisfied the security policy (150) further includes providing (925) a user visual and/or non-visual cues (735, 630) regarding said ranks (605) for said plurality of information cards.

27. An article, comprising a storage medium, said storage medium having stored thereon instructions that, when executed by a machine, result in:
receiving (1105) a request for a web site (320) at a relying party (130) from a client (105);
identifying (1110) a security policy (150) associated with the web site (320), the security policy (150) including at least one claim (405, 410, 415, 420) that is neither required nor optional (435, 440) for use of the web site (320); and
transmitting (1115) the security policy (150) to the client (105).

28. An article according to claim 27, said storage medium has stored thereon further instructions that, when executed by the machine, result in:
receiving (1120) a security token (160) from the client (105), the security token including data responsive to the claim (405, 410, 415, 420) that is neither required nor optional (435, 440) for use of the web site (320); and
using (1125) the security token (160) with the web site (320).
